(19) United States
(12) Patent Application Publication
(10) Pub. No.: US 2006/0154098 A1
(43) Pub. Date: Jul. 13, 2006

(54) Self-adhesive article

(75) Inventors: Thilo Dollase, Hamburg (DE); Marc Husemann, Hamburg (DE)

Correspondence Address: NORRIS, MCLAUGHLIN & MARCUS, P.A., 875 THIRD AVE, 18TH FLOOR, NEW YORK, NY, 10022, US

(73) Assignee: tesa AG, Hamburg (DE)

(21) Appl. No.: 10/537,469

(22) PCT Filed: Nov. 11, 2003
(86) PCT No.: PCT/EP03/12543

§ 371 Date: Jan. 18, 2006

(30) Foreign Application Priority Data
Dec. 5, 2002 (DE) 102567824

(51) Int. Cl. B32B 27/30; B32B 7/12

(52) U.S. Cl. 428/522; 428/343; 428/352; 428/353

(57) ABSTRACT

A self-adhesive article made from a sheet or strip support at least partly coated on at least one side with a pressure-sensitive adhesive material based on polyacrylate, comprising at least one polyacrylate block copolymer with a sequence of hard polymer blocks [P(A)], having a glass transition temperature of not more than 10° C., preferably of 0 to −80° C. and of soft polymer blocks [P(B)], having a glass transition temperature of more than 10° C., preferably 20 to 175° C. A microstructuring is thus generated, which permits the exchange of the smallest adhering and non-adhering regions and thus generates the desired easily stuck and easily removed adhesive action such as required for self-adhesive note pads.

The invention relates to a pressure-sensitive adhesive (PSA) article composed of a support in sheet or strip form coated on at least one side at least partly with a polyacrylate-based pressure-sensitive adhesive, and to associated blocks of these articles.

PSAs are distinguished by one particular quality. In contrast to solvent-based adhesives, they are permanently tacky and attach to a multiplicity of surfaces merely on contact, without application of any great pressure. As a result of the march of industrialization and the advantage of the inherent tack over conventional adhesives, PSAs are being used in ever greater number for a wide variety of PSA tapes. One technology, which has been known in the automobile industry for 80 years now, is the operation of painting using PSA paper masking strips. Highly varying requirements can be controlled on the one hand through the paper support and on the other hand through the PSA. Examples of suitable PSAs include polyacrylates and systems based on natural rubber or on synthetic rubber. Each PSA system has its characteristic pros and cons. Polyacrylates are highly stable to weathering and, after crosslinking, can be used within a wide temperature spectrum. Natural-rubber-based PSAs are very inexpensive, and PSAs based on synthetic rubber feature very high bond strength and tack.

Another application which is very widespread is that of sticky notes which, after bonding, can be removed again from paper, for example, without residue and without tearing. These paper strips have already been known for around 25 years. Obtaining such a quality requires particular PSAs. DE 23 27 452 describes bead polymers which impart such a quality to a self-adhesive system. These bead polymers, though, contain emulsifiers, which markedly reduce the water resistance of the PSA. This poses a problem particularly in the case of very high atmospheric humidity. Moreover, in the production operation, the water which evaporates after drying is contaminated by residual monomers, which in turn entails a costly and inconvenient purification step.

Another means of producing sticky notes is to reduce the bond strength by deliberately leaving out the PSA in certain places. Such “structuring” of the PSA can be achieved, for example, by screen-printing the acrylate PSA onto the support. This reduces the bond area and the bond strength, and so these sticky notes can be removed again without residue. The disadvantage of this process lies in costly and inconvenient production plant as compared with the conventional full-area application. For producing conventional PSAs, therefore, there continues to be a need for full-area application processes, and so a demand exists for PSAs which can be applied on a full-area basis for articles which are redetachable easily and without residue.

It is an object of the invention, therefore, to provide a pressure-sensitive adhesive article, particularly in the form of PSA sheets for notepads, which is redetachable easily, completely and without residue and which avoids the disadvantages in the prior art.

The achievement of this object envisages using, for a pressure-sensitive adhesive article of the type outlined in the introduction, a pressure-sensitive adhesive which comprises at least one polyacrylate block copolymer that has a succession of hard polymer blocks [P(A)] having a glass transition temperature of not more than 10° C. and of soft polymer blocks [P(B)] having a glass transition temperature of not less than 10° C. Further embodiments of the pressure-sensitive adhesive article of the invention are characterized in the dependent claims.

The weight fractions of the block copolymers ought in total to make up at least 50% of the pressure-sensitive adhesive.

Surprisingly and unforeseeably for the skilled worker it has been found that the pressure-sensitive adhesive used in accordance with the invention can be applied in a full-area process in which it generates a microstructuring itself as a result of self-organization. In this organizational structure the “hard” domains, which are formed by the polymer blocks having a low softening or glass transition temperature (T_{G}), give rise to the formation of very small regions which are adhesion-free or virtually so, and the “soft” domains, formed by the polymer blocks having a higher softening or glass transition temperature (TG), give rise to the formation of very small adhesive regions. As a result of this microstructuring the requirements for the relatively low bond strength and the associated complete redetachability needed for sticky notes are met.

The block copolymers used in accordance with the invention are characterized by a succession of “hard” polymer blocks [P(A) or P(A/C)] having a low softening/glass transition temperature and of “soft” polymer blocks [P(B) or P(B/D)] having a high glass transition/softening temperature, the block copolymers advantageously comprising at least one triblock copolymer structure [P(A)-P(B)—P(A) and/or P(B)—P(A)—P(B), in each of which P(A) can be substituted by P(A/C) and/or P(B) by P(B/D)]. P(A/C) and P(B/D) denote polymer blocks constructed as a copolymer of A and C or of B and D, respectively. Some advantageous embodiments are set out below by way of example.

PSAs which can be used outstandingly include, for example, those pressure-sensitive adhesives based on block copolymers of the general type P(B)—P(A/C)—P(B), in which each block copolymer is composed of a middle copolymer block P(A/C) and two end polymer blocks P(B), where
P(A/C) represents a copolymer of the monomers A and C, with P(A/C) possessing a softening/glass transition temperature of below 10° C., preferably 0° C. to −80° C., component C preferably further possessing at least one functional group which behaves inertly in a free-radical polymerization reaction, and which serves to enhance the cohesion of the block copolymer,
P(B) represents a polymer of the monomers B, with P(B) possessing a softening/glass transition temperature of at least 10° C., preferably 20° C. to 175° C.,
the polymer block P(B) is insoluble in the copolymer block P(A/C), and the blocks P(B) and P(A/C) are immiscible.

By softening temperature is meant here a glass transition temperature for amorphous systems and a melting temperature in the case of semicrystalline polymers. The temperatures stated here correspond to those obtained from quasi-steady-state experiments, such as DSC, for example.

The cohesion-enhancing effect of the copolymer P(A/C) may advantageously be brought about by bonds between the individual block copolymers P(B)—P(A/C)—P(B), with the functional groups that are preferably attached to component C of one block copolymer macromolecule interacting with at least one further block copolymer macromolecule. With particular advantage the functional group of component C induces the enhancement in cohesion by means of dipole-dipole interactions and/or hydrogen bonding. With particular preference the functional group of component C is a carboxylic acid group, a hydroxyl group or a tert-butyl group. With further particular preference at least one compound from the following group is used as component C: acrylic acid, hydroxyethyl acrylate, hydroxypropyl acrylate, methacrylic acid, methyl methacrylate, hydroxyethyl methacrylate, hydroxypropyl methacrylate, tert-butyl acrylate, itaconic anhydride, itaconic acid, acrylamides, such as N-tert-butylacrylamide, N-isopropylacrylamide or dimethylacrylamide, and maleic anhydride.

The functional groups of component C may also be groups capable of crosslinking, preferably unsaturated groups, capable in particular of radiation-chemical crosslinking, with preference being given to crosslinking which is induced by UV irradiation or by irradiation with electron beams. It has proven advantageous if the crosslinking-capable functional group of component C is an unsaturated alkyl radical having 3 to 8 carbon atoms and having at least one C—C double bond. With further particular preference the crosslinking-capable functional group of component C is a functional group which is made capable of crosslinking reaction through the influence of thermal energy. The functional group of component C is chosen advantageously as a hydroxyl, carboxyl, epoxy, acid amide, isocyanate or amino group.

Monomers for component C that can be used advantageously include at least one compound of the following general formula 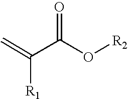
where R₁═H or CH₃ and —OR₂ constitutes or comprises the functional group according to one of the above claims. At least one compound is used as component C; component C can be selected such that it lowers the softening/glass transition temperature of the copolymer block P(A/C) to TG<° C.

As component A it is preferred to use at least one compound of the following general formula 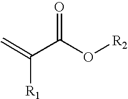
where R₁═H or CH₃ and R₂ is from the group of branched or unbranched, saturated alkyl groups having 4-14 carbon atoms.

As component B the monomers are preferably selected such that the resulting polymer blocks P(B) are capable of forming a 2-phase domain structure with the copolymer blocks P(A/C). The fraction of the polymer blocks P(B) is very preferably between 10% and 60% by weight, in particular between 15% and 40% by weight of the overall block copolymer.

Additionally the weight fraction of component C in relation to component A is advantageously between 0.1 and 20, in particular between 0.5 and 5.

A further pressure-sensitive adhesive which can be used outstandingly for the inventive purpose is based on block copolymers of the general type P(A)-P(B)—P(A) or of the type P(A/C)—P(B)—P(A/C), with each block copolymer being composed of a middle (co)polymer block P(B) and two end (co)polymer blocks P(A) or P(A/C) respectively, and being characterized in that
P(A) represents a polymer composed of at least one monomer A, with P(A) possessing a softening/glass transition temperature of 0° C. or less, or P(A/C) represents a copolymer of the monomers A and C, with P(A/C) possessing a softening/glass transition temperature of 0° C. or less, and component C preferably possessing at least one functional group which behaves inertly in a free-radical polymerization reaction, and which serves to enhance the cohesion of the block copolymer,
P(B) represents a polymer of at least one monomer B, with P(B) possessing a softening/glass transition temperature of 20° C. or more,
the (co)polymer block P(B) is insoluble in the (co)polymer block P(A) or P(A/C), respectively, and the blocks P(B) and P(A) are immiscible.

Component C preferably comprises at least one functional group which behaves inertly in a free-radical polymerization reaction and which serves to increase the cohesion of the block copolymer; in particular through bonds between the individual block copolymers, with the functional group of component C of one block copolymer macromolecule interacting with at least one further block copolymer macromolecule; in particular through a crosslinking reaction. The functional group for increasing the cohesion may with very great advantage be a hydroxyl, carboxyl, epoxy, acid amide, isocyanate or amino group, a group comprising a photoinitiator for UV crosslinking, or an unsaturated group.

With further advantage the block P(A) and/or P(A/C) possesses a softening/glass transition temperature of between −80° C. and 0° C. and/or the block P(B) possesses a softening/glass transition temperature of between 25° C. and 180° C.

The fraction of the (co)polymer blocks P(B) is preferably between 10% and 60% by weight, in particular between 15% and 40% by weight of the overall block copolymer.

Advantageously the weight fraction of component C in relation to component A is between 0.1 and 20, in particular between 0.5 and 10.

A further pressure-sensitive adhesive which can be used with advantage is one based on block copolymers of the general type P(B/D)-P(A)-P(B/D), each block copolymer being composed of a middle copolymer block P(A) and two end polymer blocks P(B/D), characterized in that
P(A) represents a polymer of the monomers A which possesses a softening/glass transition temperature of 0° C. to −80° C., it being possible for component A to comprise one or more monomers, and the softening/glass transition temperature of the block P(A) being below 0° C.
P(B/D) represents a polymer of at least two monomers B and D, the block P(B/D) possessing a softening/glass transition temperature of 20° C. to 175° C., and component D comprising at least one functional group capable of crosslinking,
the polymer block P(A) is insoluble in the copolymer block P(B/D), and the blocks P(A) and P(B/D) are immiscible.

In this case the crosslinking-capable functional group of component D is advantageously an unsaturated group which is capable preferably of radiation-chemical crosslinking, in particular of a crosslinking which is brought about by UV irradiation or by irradiation with electron beams. This may preferably be an unsaturated alkyl radical which has at least one C—C double bond. The crosslinking-capable functional group of component D may with further advantage be a group which is capable of a crosslinking reaction through the influence of thermal energy. A functional group of component D that may be chosen with advantage is a hydroxyl, carboxyl, epoxy, acid amide, isocyanate or amino group.

In one preferred exemplary embodiment at least one compound which raises the softening/glass transition temperature of the copolymer block P(B/D) to TG>20° C. is used as component D.

As components B and D, monomers are chosen, preferably, which render the block P(B/D) capable of forming a 2-phase domain structure with the copolymer block P(A), it also being possible for B and D to be identical. Advantageously the fraction of the polymer blocks P(B/D) is between 10% and 60% by weight, in particular between 15% and 40% by weight, of the overall block copolymer. With further advantage the weight fraction of component D in relation to component B is between 0.1 and 20, in particular between 0.5 and 5.

The acrylate block copolymers used in the invention preferably have an inherent orientation. As a result of this the PSAs obtained possess a preferential direction, the refractive index measured in the preferential direction, n_{MD}, being greater than the refractive index n_{CD} measured in a direction perpendicular to the preferential direction.

With particular preference the difference Δn=n_{MD}−n_{CD} amounts to at least 1·10⁻⁵. With further advantage the PSA exhibits a shrinkback of at least 5%, measured as follows:

The PSA is coated from the melt through a die onto a siliconized release paper. Strips at least 30 mm wide and 20 cm long are cut parallel to the coating direction of the hotmelt. At application rates of 130 g/m², 3 strips, and at 50 g/m² 8 strips, are laminated together in order to give comparable layer thicknesses. The specimen obtained in this way is then cut to a width of 20 mm exactly, and strips of paper are stuck over it at each end with a spacing of 15 cm. The test specimen thus prepared is then suspended vertically at room temperature and the change in length is monitored over time until no further contraction of the sample can be ascertained. The initial length, reduced by the final value, is then expressed as the shrinkback in percent based on the initial length.

As a result of the orientation it is possible to reduce the bond strength still further and hence to enhance the reversibility of the inventive product.

The structure of at least one block copolymer can be described advantageously by means of one or more of the following general formulae:
P(B)—P(A)-P(B) (I)
P(A)-P(B)—P(A)-P(B)—P(A) (II)
[P(A)-P(B)]ₙX (III)
[P(A)-P(B)ₙX[P(B)]ₘ (IV)
where n=3 to 12, m=3 to 12 and X represents a multifunctional branching region,
where the polymer blocks P(B) independently of one another represent homopolymer or copolymer blocks of the monomers B, with the polymer blocks P(B) each having a softening temperature in the range from +20° C. to +175° C.,

and where the polymer blocks P(A) independently of one another represent homopolymer or copolymer blocks of the monomers A, with the polymer blocks P(A) each having a softening temperature in the range from −130° C. to +10° C.

With further advantage at least one block copolymer has a symmetrical structure such that there are polymer blocks P(B) identical in chain length and/or chemical structure, and/or such that there are polymer blocks P(A) identical in chain length and/or chemical structure.

In one preferred embodiment of the PSAs used in accordance with the invention they have different stress/strain characteristics in the lengthwise and transverse directions.

It is advantageous if at least one block copolymer meets one or more of the following criteria:
a molar mass Mₙ of between 25 000 and 600 000 g/mol, preferably between 30 000 and 400 000 g/mol, more preferably between 50 000 and 300 000 g/mol,
a polydispersity D=M_{w}/Mₙ of not more than 3,
a polymer block P(B) fraction of between 5% and 49%, preferably between 7.5% and 35%, in particular between 10% and 30% by weight, based on the triblock copolymer composition,
one or more grafted-on side chains.

In particular the ratio of the chain lengths of the polymer blocks P(B) to those of the polymer blocks P(A) may be chosen such that the polymer blocks P(B) are present in the form of a disperse phase (“domains”) in a continuous matrix of the polymer blocks P(A), in particular as spherical or distortedly spherical or cylindrical domains.

Thus it is possible to make outstanding use of a polymer blend of two or more block copolymers corresponding to the details above, and also of a blend of one or more block copolymers corresponding to the details above with at least one diblock copolymer P(B)—P(A),
where the polymer blocks P(B) independently of one another represent homopolymer or copolymer blocks of the monomers B, with the polymer blocks P(B) each having a softening temperature in the range from +20° C. to +175° C.,
and where the polymer blocks P(A) independently of one another represent homopolymer or copolymer blocks of the monomers A, with the polymer blocks P(A) each having a softening temperature in the range from −130° C. to +10° C., and/or with at least one polymer P′ (B) and/or P′(A),
where the polymers P′ (B) represent homopolymers and/or copolymers of the monomers B, with the polymers P′ (B) each having a softening temperature in the range from +20° C. to +175° C.,
where the polymers P′ (A) represent homopolymers and/or copolymers of the monomers A, with the polymers P′ (A) each having a softening temperature in the range from −130° C. to +10° C.

A further possibility for use, outstandingly, in the context of the invention is a blend of at least two components K1 and K2, each component being based on at least one block copolymer P1 and P2 respectively,
where the at least one block copolymer P1 of component K1 comprises at least the unit P(B1)-P(A1)- P(B1) comprising at least one polymer block P(A1) and at least two polymer blocks P(B1), with
   P(B1) independently of one another representing homopolymer or copolymer blocks of monomers B1, with the polymer blocks P(B1) each having a softening temperature in the range from +20° C. to +175° C.,
   P(A1) represents a homopolymer or copolymer block of monomers A1, with the polymer block P(A1) having a softening temperature in the range from −130° C. to +10° C.,
   the polymer blocks P(B1) and P(A1) are not homogeneously miscible with one another,
where the at least one block copolymer P2 of component K2 comprises at least the unit P(A2)-P(B2)-P(A2) comprising at least two polymer blocks P(A2) and at least one polymer block P(B2), and with
   P(B2) representing a homopolymer or copolymer block of monomers B2, with the polymer block P(B2) having a softening temperature in the range from +20° C. to +175° C.,
   P(A2) independently of one another represents homopolymer or copolymer blocks of monomers A2, with the polymer blocks P(A2) each having a softening temperature in the range from −130 to +10° C.,
   the polymer blocks P(B2) and P(A2) are not homogeneously miscible with one another,
and where the blend forms an at least two-phase system.

With advantage the ratio V of the amount m_{K2} of component K2 used in the blend to the amount m_{K1} of component K1 used in the blend is up to 250 parts by weight of K2 to 100 parts by weight of K1, i.e., V=m_{K2}/m_{K1}≦2.5.

Preferably the blocks P(B1) are compatible with the blocks P(B2) and/or their corresponding polymers P′ (B1) are compatible in each case with P′ (B2) and/or the blocks P(A1) are compatible with the blocks P(A2) and/or their corresponding polymers P′ (A1) are compatible in each case with P′ (A2).

With further advantage the polymer blocks P(B1) and the polymer blocks P(B2) and/or the polymer blocks P(A1) and the polymer P(A2) possess an identical homopolymer and/or copolymer composition.

It is advantageous if the average chain length LA2 of the polymer blocks P(A2) of the block copolymer P2 does not exceed the average chain length LA1 of the polymer block P(A1) of the block copolymer P1, with LA2 being advantageously at least 10% less than LA1, and with LA2 being very advantageously at least 20% less than LA1. It is further of advantage if the polymer blocks P(Bi) (i=1, 2, . . . ) are present as a disperse phase (“domains”) in a continuous matrix of the polymer blocks P(Ai), preferably as spherical or distortedly spherical domains, this state being attained in particular by adjusting the ratio V_{Li} of the average chain lengths LBi of the polymer blocks P(Bi) to the average chain lengths LAi of the polymer blocks P(Ai) of the block copolymers Pi, very preferably by adjusting the ratio V_{L1} of the block copolymer P1.

In addition to the PSAs particularly suitable above, mention may also be made of those which have star structures, corresponding for instance to

[P(A)-P(B)]ₙX

[P(B)—P(A)]ₙX

[P(B)—P(A)-P(B)]ₙX

[P(A)-P(B)—P(A)]ₙX
or, generally, 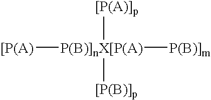
where m, n, p and q independently of one another =0, 1, 2, 3 . . . and X represents a multifunctional branching unit, i.e., a chemical structural element via which two or more polymer arms are linked to one another.

In this context it is also possible for there to be two or more branching units in the polymers.

Monomers A used with advantage for the copolymer blocks P(A) and/or P(A/C) of the PSAs used in accordance with the invention are acrylic monomers or vinyl monomers, more preferably those which lower the softening/glass transition temperature of the copolymer block P(A/C)—both alone and in combination with monomer C—to below 10° C., very preferably below 0° C.

Very advantageously for the PSA of the invention, use is made as component A of one or more compounds which can be described by the following general formula:

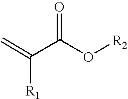

In this formula R₁═H or CH₃ and the radical R₂ is chosen from the group of branched or unbranched, saturated alkyl groups having 4 to 14 carbon atoms.

Acrylic monomers which are used with preference for the inventive PSA, as component A, include acrylic and methacrylic esters with alkyl groups consisting of 4 to 14 carbon atoms, preferably 4 to 9 carbon atoms. Specific examples, without wishing to be restricted by this enumeration, are n-butyl acrylate, n-pentyl acrylate, n-hexyl acrylate, n-heptyl acrylate, n-octyl acrylate, n-nonyl acrylate and the branched isomers thereof, such as 2-ethylhexyl acrylate, for example. Furthermore, optionally, vinyl monomers from the following groups are used as monomer A:

vinyl esters, vinyl ethers, vinyl halides, vinylidene halides, vinyl compounds with aromatic rings and heterocycles in α position.

Here as well, mention may be made nonexclusively of some examples: vinyl acetate, vinylformamide, vinylpyridine, ethyl vinyl ether, vinyl chloride, vinylidene chloride, acrylonitrile.

The monomers B for the copolymer blocks P(B) and/or P(B/D) of the PSAs used in accordance with the invention are preferably chosen such that the resulting blocks P(B) and/or P(B/D) are capable of forming a 2-phase domain structure with the copolymer blocks P(A) and/or P(A/C). A prerequisite for this is the immiscibility of the blocks P(B) or P(B/D) with the blocks P(A) or P(A/C) respectively. Within the 2-phase domain structure, regions are formed in which the blocks of different (and, where appropriate, identical) chains of one and the same variety of monomer mixed with one another. These domains, as they are called, are embedded in a matrix of the blocks of the other variety of monomer. A characteristic possessed by such a 2-phase domain structure is two softening/glass transition temperatures.

With the formation of two phases of different properties, hard volume elements are obtained alongside soft volume elements.

Advantageous examples of compounds which are used as component B are vinylaromatics, methyl methacrylates, cyclohexyl methacrylates, and isobornyl methacrylates. Particularly preferred examples of component B are methyl methacrylate and styrene.

As monomers C it is preferred to use acrylic monomers or vinyl monomers which lower the softening/glass transition temperature of the copolymer block P(A/C)—alone or in combination with monomer A—to below 0° C. In one advantageous version of the process of the invention, acrylic monomers are used, particularly those corresponding to the following general formula: 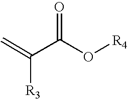
where R₃═H or CH₃ and the radical —OR₄ represents or comprises the functional group for raising the cohesion of the PSA.

Examples of component C are hydroxyethyl acrylate, hydroxypropyl acrylate, hydroxyethyl methacrylate, hydroxypropyl methacrylate, acrylic acid, methacrylic acid, methyl methacrylate, t-butyl acrylate, allyl alcohol, maleic anhydride, itaconic anhydride, itaconic acid, benzoin acrylate, acrylated benzophenone, acrylamides (such as N-t-butylacrylamide, N-isopropyl-acrylamide and dimethylacrylamide, for example) and glyceridyl methacrylate, this enumeration not being exhaustive.

Preferably chosen in this context are:
a) for dipole-dipole interaction and/or hydrogen bond formation properties:

acrylic acid, methacrylic acid and itaconic acid, but also Hydroxyethyl acetate, hydroxypropyl acetate, allyl alcohol, acrylamides, Hydroxyethyl methacrylate and methyl methacrylate
b) for crosslinking with high-energy radiation: benzoin acrylate and acrylated benzophenone
c) for thermal crosslinking:

hydroxyethyl acrylate, hydroxypropyl acrylate, Hydroxyethyl methacrylate, hydroxypropyl meth-acrylate, acrylic acid, methacrylic acid, allyl alcohol, maleic anhydride, itaconic anhydride, itaconic acid, glyceridyl methacrylate, but also all acrylamides.

With t-butyl acrylate and, for example, stearyl acrylate an additional increase is brought about in the softening/glass transition temperature. The polymers resulting from this have a higher molecular weight and a restricted mobility.

As monomer D use is made preferably of acrylic monomers or vinyl monomers which raise the softening/glass transition temperature of the copolymer block P(A/C)—alone or in combination with monomer A—to more than 20° C.

Particularly preferred examples of component C are acrylated photoinitiators, such as benzoin acrylate or acrylated benzophenone, for example, Hydroxyethyl methacrylate, hydroxypropyl methacrylate, acrylic acid, methacrylic acid, allyl alcohol, maleic anhydride, itaconic anhydride, itaconic acid, acrylamide and glyceridyl methacrylate, this enumeration not being exhaustive.

The polymerization can be carried out in accordance with a process known per se or in modification of a process known per se, in particular by conventional free-radical polymerization and/or by controlled free-radical polymerization; the latter is characterized by the presence of suitable control reagents.

For preparing the block copolymers it is possible in principle to use any polymerizations which proceed in accordance with a controlled or living mechanism, and also combinations of different controlled polymerization processes. Here mention may be made, for example, without any claim to completeness, and in addition to anionic polymerization, of ATRP, nitroxide/TEMPO-controlled polymerization or, more preferably, of the RAFT process, i.e., in particular, processes of a kind which allow a control over block lengths, over polymer architecture or else, but not necessarily, over the tacticity of the polymer chain.

Free-radical polymerizations can be conducted in the presence of an organic solvent or in the presence of water or in mixtures of organic solvents and/or organic solvents with water, or without solvent. It is preferred to use as little solvent as possible. The polymerization time for free-radical processes, depending on conversion and temperature, is typically between 4 and 72 h.

In the case of solution polymerization the solvents used are preferably esters of saturated carboxylic acids (such as ethyl acetate), aliphatic hydrocarbons (such as n-hexane, n-heptane or cyclohexane), ketones (such as acetone or methyl ethyl ketone), special boiling point spirit, aromatic solvents such as toluene or xylene, or mixtures of aforementioned solvents. For polymerization in aqueous media or in mixtures of organic and aqueous solvents it is preferred to add emulsifiers and stablizers to the polymerization.

With further advantage the block copolymer used in accordance with the invention may be prepared via an anionic polymerization. In this case the reaction medium used comprises preferably inert solvents, such as aliphatic and cycloaliphatic hydrocarbons, for example, or else aromatic hydrocarbons.

The living polymer is generally represented by the structure P_{L}(A)-Me, where Me is a metal from group I, such as lithium, sodium or potassium, and P_{L}(A) is a growing polymer block of the monomers A. The molar mass of the polymer block under preparation is determined by the ratio of initiator concentration to monomer concentration. In order to construct the block structure, first of all the monomers A are added for the construction of a polymer block P(A), then, by adding the monomers B, a polymer block P(B) is attached, and subsequently, by again adding monomers A, a further polymer block P(A) is polymerized on, so as to form a triblock copolymer P(A)-P(B)—P(A). Alternatively, P(A)-P(B)-M can be coupled by means of a suitable difunctional compound. In this way it is also possible to obtain star-block copolymers (P(B)—P(A))ₙ. Examples of suitable polymerization initiators include n-propyllithium, n-butyllithium, sec-butyllithium, 2-naphthyllithium, cyclohexyllithium or octyllithium, but this enumeration makes no claim to completeness. Initiators based on samarium complexes are also known for the polymerization of acrylates (Macromolecules, 1995, 28, 7886) and can be used here.

It is also possible, moreover, to use difunctional initiators, such as 1,1,4,4-tetraphenyl-1,4-dilithiobutane or 1,1,4,4-tetraphenyl-1,4-dilithioiso-butane, for example. Coinitiators may likewise be employed. Suitable coinitiators include lithium halides, alkali metal alkoxides or alkylaluminum compounds. In one very preferred version the ligands and coinitiators are chosen so that acrylate monomers, such as n-butyl acrylate and 2-ethylhexyl acrylate, for example, can be polymerized directly and do not have to be generated in the polymer by transesterification with the corresponding alcohol.

Where a method of free-radical polymerization is employed, it is advantageous to use polymerization initiators comprising customary free-radical-forming compounds such as peroxides, azo compounds and peroxo-sulfates, for example. Initiator mixtures, too, are outstandingly suitable.

In an advantageous procedure radical stabilization is effected using nitroxides of type (NIT 1) or (NIT 2): 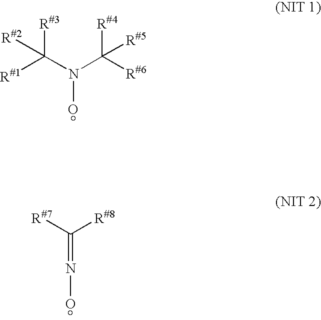
where R^{#1}, R^{#2}, R^{#3}, R^{#4}, R^{#5}, R^{#6}, R^{#7} and R^{#8} independently of one another denote the following compounds or atoms:
i) halides, such as chlorine, bromine or iodine, for example,
ii) linear, branched, cyclic and heterocyclic hydrocarbons having 1 to 20 carbon atoms, which can be saturated, unsaturated or aromatic,
iii) esters —COOR^{#9}, alkoxides —OR^{#10} and/or phosphonates —PO(OR^{#11})₂, where R^{#9}, R^{#10} and/or R^{#11} stand for radicals from group ii).

Compounds of structure (NIT 1) or (NIT 2) may also be attached to polymer chains of any kind (primarily in the sense that at least one of the abovementioned radicals constitutes such a polymer chain).

Greater preference is acquired by controlled regulators for the polymerization of compounds of the following type:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-1-piperidinyloxy]pyrrolidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-t-butyl nitroxide
diphenyl nitroxide
t-butyl t-amyl nitroxide

U.S. Pat. No. 4,581,429 A discloses a controlled-growth free-35 radical polymerization process initiated using a compound of the formula R′R″N—O—Y in which Y is a free radical species which is able to polymerize unsaturated monomers. The reactions, however, generally have low conversions. A particular problem is the polymerization of acrylates, which proceeds only at very low yields and molar masses. WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process using very specific radical compounds such as, for example, phosphorus-containing nitroxides which are based on imidazolidine. WO 98/44008 A1 discloses specific nitroxyls based on morpholines, piperazinones and piperazinediones. DE 199 49 352 A1 describes heterocyclic alkoxyamines as regulators in controlled-growth free-radical polymerizations. Corresponding further developments of the alkoxyamines or of the corresponding free nitroxides enhance the efficiency for preparing polyacrylates (Hawker, Paper to the National Meeting of the American Chemical Society, spring 1997; Husemann, Paper to the IUPAC World Polymer Meeting 1998, Gold Coast).

As a further controlled polymerization method it is possible advantageously to use Atom Transfer Radical Polymerization (ATRP) to synthesize the block copolymers, with preferably monofunctional or difunctional secondary or tertiary halides being used as initiator and, to abstract the halide(s), complexes of Cu, Ni, Fe, Pd, Pt, Ru, Os, Rh, Co, Ir, Ag or Au (EP 0 824 111 A1; EP 826 698 A1; EP 824 110 A1; EP 841 346 A1; EP 850 957 A1). The various possibilities of ATRP are further described in U.S. Pat. No. 5,945,491 A, U.S. Pat. No. 5,854,364 A and U.S. Pat. No. 5,789,487 A.

One very preferred preparation process conducted is a variant of the RAFT polymerization (reversible addition-fragmentation chain transfer polymerization). The polymerization process is described in detail, for example, in WO 98/01478 A1 and WO 99/31144 A1. In one very advantageous version, for example, the trithiocarbonates (TTC 1) and (TTC 2) or the thio compounds (THI 1) and (THI 2) are used for the polymerization, where φ can be a phenyl ring, which can be unfunctionalized or functionalized by alkyl or aryl substituents attached directly or via ester or ether bridges, or may be a cyano group, or may be a saturated or unsaturated aliphatic radical.

Functionalizations for the phenyl ring φ may be, for example, halogens, hydroxyl groups, epoxide groups, and groups containing nitrogen or containing sulfur, without this list making any claim to completeness.

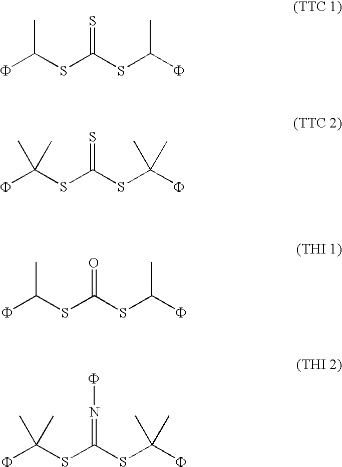

It is also possible to employ thioesters of the general structure
R^{$1}—C(S)—S—R^{$2}(THE)
particularly in order to prepare asymmetric systems.

Here, R^{$1} and R^{$2} may be chosen independently of one another and R^{$1} may be a radical from one of the following groups i) to iv) and R^{$2} a radical from one of the following groups i) to iii):
i) C₁ to C₁₈ alkyl, C₂ to C₁₈ alkenyl, C₂ to C₁₈ alkynyl, each linear or branched; aryl-, phenyl-, benzyl-, aliphatic and aromatic heterocycles.
ii) —NH₂, —NH—R^{$3}—NR^{$3}R^{$4}, —NH—C(O)—R^{$3} NR^{$3}—C(O)—R^{$4}—NH—C(S)—R^{$3}—NR^{$3}—C(S)—R^{$4},

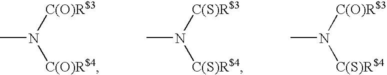

where R^{$3} and R^{$4} are radicals chosen independently of one another from group i).
(iii) —S—R^{$5}, —S—C(S)—R^{$5}, where R^{$5} can be a radical from one of groups i) or ii).
(iv) —O—R^{$6}—O—C(O)—R^{$6}, where R^{$6} can be a radical chosen from one of groups i) or ii).

In connection with the abovementioned polymerizations which proceed by controlled freeradical mechanisms it is preferred to use initiator systems which further comprise free-radical initiators for the polymerization, especially thermally decomposing, free-radical-forming azo or peroxo initiators. In principle, however, all customary initiators known for acrylates are suitable for this purpose. The production of C-centered radicals is described in Houben-Weyl, Methoden der Organischen Chemie, Vol. E19a, p. 60ff. These methods are employed preferentially. Examples of radical sources are peroxides, hydroperoxides and azo compounds. A number of nonexclusive examples that may be mentioned here of typical free-radical initiators include the following: potassium peroxodisulfate, dibenzoyl peroxide, cumene hydroperoxide, cyclohexanone peroxide, cyclohexylsulfonyl acetyl peroxide, di-tert-butyl peroxide, azodiisobutyronitrile, diisopropyl percarbonate, tert-butyl peroctoate and benzpinacol. In one very preferred version the radical initiator used is 1,1′-azobis(cyclohexylnitrile) (Vazo 88®, DuPont®) or 2,2-azobis(2-methylbutanenitrile) (Vazo 67®, DuPont®). Furthermore, it is also possible to use radical sources which release free radicals only under UV irradiation.

In the case of the conventional RAFT process, polymerization is generally carried out only to low conversions (WO 98/01478 A1) in order to obtain very narrow molecular weight distributions. Because of the low conversions, however, these polymers cannot be used as PSAs and particularly not as hotmelt PSAS, since the high residual monomer fraction adversely affects the adhesive properties, the residual monomers contaminate the solvent recyclate in the concentration process, and the corresponding self-adhesive tapes would exhibit very high outgassing.

The solvent is preferably stripped off under reduced pressure in a concentrating extruder, for which purpose it is possible to use, for example, single-screw or twin-screw extruders, which preferably distil off the solvent in different or the same vacuum stages and which possess a feed preheater.

For further development of the invention it is possible to admix tackifier resins to the block-copolymer PSAs. In principle it is possible to use all resins which are soluble in the corresponding polyacrylate middle block P(B). Suitable tackifier resins include rosin and rosin derivatives (rosin esters, including rosin derivatives stabilized by means, for example, of disproportionation or hydrogenation), polyterpene resins, terpene-phenolic resins, alkylphenolic resins, and aliphatic, aromatic and aliphatic-aromatic hydrocarbon resins, to name but a few. Resins chosen are primarily those which are preferably compatible with the elastomer block. The weight fraction of the resins as a proportion of the block copolymer is typically up to 40%, more preferably up to 30%, by weight.

For one specific mode of performing the invention it is also possible to use resins which are compatible with the polymer block P(A).

It is also possible, optionally, to add plasticizers, fillers (e.g., fibers, carbon black, zinc oxide, titanium dioxide, chalk, solid or hollow glass beads, microbeads made of other materials, silica, silicates), nucleators, expandants, compounding agents and/or aging inhibitors, in the form for example of primary and secondary antioxidants or in the form of light stabilizers.

Generally with these additives, such as resins, fillers and plasticizers, it should be ensured that they do not impair the outgassing. Preferably, therefore, substances should be used which possess very low volatility even under a high temperature load.

The internal strength (cohesion) of the PSA is preferably produced by the physical crosslinking of the polymer blocks P(A). The resultant physical cross-linking is typically thermoreversible. For irreversible crosslinking, the PSAs may additionally be crosslinked chemically. For that purpose the acrylate block copolymer PSAs which are used for the reversible systems of the invention may optionally comprise compatible crosslinker substances. Examples of suitable crosslinkers include metal chelates, polyfunctional isocyanates, polyfunctional amines or polyfunctional alcohols. Polyfunctional acrylates as well can be used with advantage as crosslinkers for actinic irradiation.

For optional crosslinking with UV light, UV-absorbing photoinitiators are added to the polyacrylate block copolymers employed in the systems of the invention. Useful photoinitiators which can be used to very good effect include benzoin ethers, such as benzoin methyl ether and benzoin isopropyl ether, substituted acetophenones, such as 2,2-diethoxyacetophenone (available as Irgacure 651® from Ciba Geigy®), 2,2-dimethoxy-2-phenyl-1-phenylethanone and dimethoxy-hydroxyacetophenone, substituted α-ketols, such as 2-methoxy-2-hydroxypropiophenone, aromatic sulfonyl chlorides, such as 2-naphthylsulfonyl chloride, and photoactive oximes, such as 1-phenyl-1,2-propanedione 2-(O-ethoxycarbonyl) oxime, for example.

The abovementioned photoinitiators and others which can be used, including those of the Norrish I or Norrish II type, may contain the following radicals: benzophenone-acetophenone-, benzyl-, benzoin-, hydroxyalkylphenone-, phenyl cyclohexyl ketone-, anthraquinone-, trimethyl-benzoylphosphine oxide-, methylthiophenyl morpholine ketone-, aminoketone-, azobenzoin-, thioxanthone-, hexaarylbisimidazole-, triazine-, or fluoroenone, it being possible for each of these radicals additionally to be substituted by one or more halogen atoms and/or by one or more alkyloxy groups and/or by one or more amino groups or hydroxyl groups. A representative overview is given by Fouassier: “Photoinitiation, Photopolymerization and Photocuring: Fundamentals and Applications”, Hanser-Verlag, Munich 1995. For further details, Carroy et al. in “Chemistry and Technology of UV and EB Formulation for Coatings, Inks and Paints”, Oldring (ed.), 1994, SITA, London, can be consulted.

In principle it is also possible to crosslink the PSAs used in accordance with the invention using electron beams. Typical irradiation devices which may be employed include linear cathode systems, scanner systems and segmented cathode systems, in the case of electron beam accelerators. A detailed description of the state of the art, and the most important process parameters, are found in Skelhorne, Electron Beam Processing, in Chemistry and Technology of UV and EB formulation for Coatings, Inks and Paints, Vol. 1, 1991, SITA, London. The typical acceleration voltages are situated in the range between 50 kV and 500 kV, preferably 80 kV and 300 kV. The scatter doses employed range between 5 to 150 kGy, in particular between 20 and 100 kGy.

Product Constructions of the PSA Sheet Materials

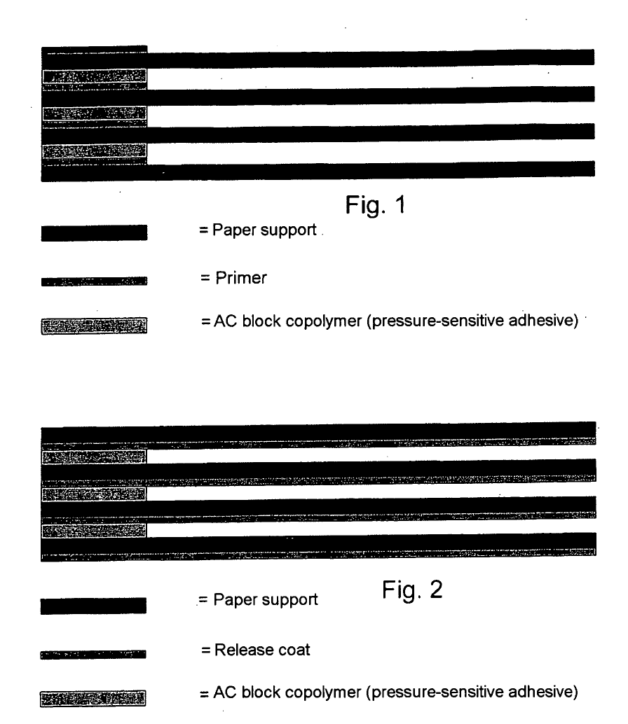

FIGS. 1 to 3 show different product constructions of the PSA articles of the invention. The number of PSA sheets laminated atop one another is variable and is preferably at least 2.

According to FIG. 1 the paper support is provided with a primer, which improves the anchorage of the PSA to the paper. Here it is possible to use a multiplicity of the primer materials that are familiar to the skilled worker, such as, for example, primers based on styrene block copolymers. The primer is coated onto the paper support only in one subregion. The area, in one very preferred version, is identical with the area of the PSA.

According to FIG. 2, for the purpose of easier release of the individual PSA sheets, the reverse is provided with a release material. Suitable release materials include all materials that are known to the skilled worker, with particular preference systems based on polysilicones or on fluorinated hydrocarbons. It is also possible, however, to use all other known release coating materials. The PSA sheets may be provided with the release coating material over their full area or only in a subregion.

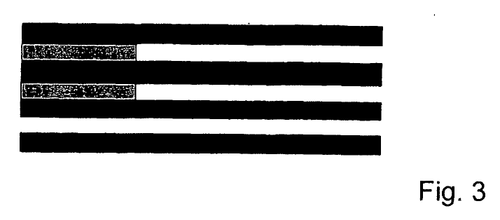

According to FIG. 3 the PSA is coated directly on the paper support. In this case the anchorage is sufficiently high that the PSA paper sheets can be removed without residue.

In addition to the versions set out above, combinations of the individual product variants may also be prepared, however. Thus, for example, the paper support may be provided both with a primer and with a release coating material on the opposite side, and subsequently the PSA block copolymer coated onto the primer coat.

Paper supports which can be used include all known paper materials. As well as graphics papers, colored papers, gravure papers, offset papers, printing papers of general kind, or transparent papers may be used, this enumeration making no claim to completeness. Additionally, the paper supports may also differ in basis weight, with preference being given to the use of basis weights of between 30 and 250 g/m². Moreover, use is made of papers coated on one or two sides, one-, two- or three-ply papers, glossy, matt or ultrathin papers, mechanical papers or papers based on an environmental fiber mix, recycled papers, papers with various fillers, or papers based on chemical pulps. Paper manufacturers for the abovementioned papers are, for example, the companies Steinbeis, Neusiedler, Zanders or Meerssen & Palm.

The pressure-sensitively adhesive sheet materials described above and produced can be used as notes. The paper support materials are easily written on and, as a result of the PSA treatment, bond temporarily to a variety of substrates. As a result of the composition of the PSAs, the pressure-sensitively adhesive sheet material can be removed without residue and easily, reversibly, from a wide variety of substrates.

Additionally, the pressure-sensitively adhesive sheet materials described and produced can be used for medical purposes, such as for bonding on the skin, for example.

Test Methods

A. Bond Strength

The peel strength (bond strength) was tested in accordance with PSTC-1. The bond strength specimens were produced by coating the polymers from solution onto a graphics paper from Paper Union GmbH & CO. KG, Kompass Copy TCF office, 80 g/m² with subsequent drying at 100° C. The application rate after the drying operation was 10 g/m². A strip of this sample 2 cm wide is adhered to a steel plate, provided with the identical paper, by being rolled over back and forth once using a 2 kg roller. The plate is clamped in and the PSA paper strip is peeled off from its free end on a tensile testing machine under a peel angle of 180° and at a speed of 300 mm/min.

B. Gel Permeation Chromatography (GPC)

The average molecular weight M_{w} and the polydispersity PD were determined by means of gel permeation chromatography. The eluent used was THF containing 0.1% by volume trifluoroacetic acid. Measurement was carried out at 25° C. The precolumn used was PSS-SDV, 5μ, 10³ Å, ID 8.0 mm×50 mm. Separation was carried out using the columns PSS-SDV, 5μ, 10³ and also 10⁵ and 10⁶ each with ID 8.0 mm×300 mm. The sample concentration was 4 g/l, the flow rate 1.0 ml per minute. Measurement was carried out against polystyrene standards.

Production of Test Specimens

Preparation of a RAFT Regulator:

The regulator bis-2,2′-phenylethyl trithiocarbonate (formula TTC-1) was prepared starting from 2-phenylethyl bromide using carbon disulfide and sodium hydroxide in accordance with a specification from Synth. Comm., 1988, 18 (13), 1531. Yield 72%. ¹H-NMR (CDCl₃, δ: 7.20-7.40 ppm (m, 10H); 3.81 ppm (m, 1H); 3.71 ppm (m, 1H); 1.59 ppm (d, 3H); 1.53 ppm (d, 3H).

Preparation of Polystyrene (PS):

A 2 L reactor conventional for free-radical polymerization is charged under a nitrogen atmosphere with 362 g of styrene and 3.64 g of bis-2,2′-phenylethyl trithiocarbonate regulator. This initial charge is heated to an internal temperature of 110° C. and initiation is carried out with 0.15 g of Vaso 67® (DuPont). After a reaction time of 10 hours 100 g of toluene are added. After a reaction time of 24 hours initiation is carried out with a further 0.1 g of Vazo 67® and polymerization is carried out for a further 24 hours. During the polymerization there is a marked increase in viscosity. This is compensated by adding 150 g of toluene as final dilution after 48 hours.

For purification the polymer was precipitated from 4.5 liters of methanol, filtered off on a frit and subsequently dried in a vacuum drying cabinet.

Gel permeation chromatography (test B) against poly-styrene standards gave M_{N}=29 300 g/mol and M_{W}=35 500 g/mol.

### EXAMPLE 1

In a second step, 48.5 g of polystyrene PS were mixed, in a reactor conventional for free-radical polymerizations, with 64 g of stearyl methacrylate, 256 g of 2-ethylhexyl acrylate and 100 g of acetone. After half an hour of inertization under nitrogen gas, the mixture is heated to an internal temperature of 60° C. and initiated with 0.1 g of Vazo 67® (DuPont) in solution in 5 g of acetone. After a reaction time of 4 hours initiation is carried out with a further 0.1 g of Vazo 67® in solution in 10 g of acetone. After a reaction time of 10 hours dilution is carried out with 150 g of acetone. The polymerization is terminated by cooling after a reaction time of 28 hours, and the product is diluted down to 30% by addition of special boiling point spirit 60/95.

Gel permeation chromatography (test B) against polystyrene standards gave M_{N}=99 700 g/mol and M_{W}=208 000 g/mol.

### EXAMPLE 2

In a second step, 48.5 g of polystyrene PS were mixed, in a reactor conventional for free-radical polymerizations, with 64 g of stearyl methacrylate, 256 g of n-butyl acrylate and 100 g of acetone. After half an hour of inertization under nitrogen gas, the mixture is heated to an internal temperature of 60° C. and initiated with 0.1 g of Vazo 67® (DuPont) in solution in 5 g of acetone. After a reaction time of 4 hours initiation is carried out with a further 0.1 g of Vazo 67® in solution in 10 g of acetone. After a reaction time of 10 hours dilution is carried out with 150 g of acetone. The polymerization is terminated by cooling after a reaction time of 28 hours, and the product is diluted down to 30% by addition of special boiling point spirit 60/95.

Gel permeation chromatography (test B) against polystyrene standards gave M_{N}=131 000 g/mol and M_{W}=279 000 g/mol.

### EXAMPLE 3

In a second step, 48.5 g of polystyrene PS were mixed, in a reactor conventional for free-radical polymerizations, with 96 g of stearyl acrylate, 222.4 g of 2-ethylhexyl acrylate, 1.6 g of acrylic acid and 100 g of acetone/special boiling point spirit 60/95 (1:1). After half an hour of inertization under nitrogen gas, the mixture is heated to an internal temperature of 60° C. and initiated with 0.15 g of Vazo 67® (DuPont) in solution in 5 g of acetone. After a reaction time of 1.5 hours initiation is carried out with a further 0.15 g of Vazo 67® in solution in 5 g of acetone. After a reaction time of 3 hours, 4.75 hours, 6 hours and 6.5 hours dilution is carried out with 50 g of acetone each time. The polymerization is terminated by cooling after a reaction time of 24 hours, and the product is diluted down to 30% by addition of special boiling point spirit 60/95.

Gel permeation chromatography (test B) against polystyrene standards gave M_{N}=108 000 g/mol and M_{W}=223 000 g/mol.

### EXAMPLE 4

In a second step, 59 g of polystyrene PS were mixed, in a reactor conventional for free-radical polymerizations, with 94.1 g of stearyl acrylate, 174.7 g of 2-ethylhexyl acrylate, and 100 g of acetone/special boiling point spirit 60/95 (1:1). After half an hour of inertization under nitrogen gas, the mixture is heated to an internal temperature of 60° C. and initiated with 0.15 g of Vazo 67® (DuPont) in solution in 5 g of acetone. After a reaction time of 1.5 hours initiation is carried out with a further 0.15 g of Vazo 67® in solution in 5 g of acetone. Dilution is carried out after 3.5 hours with 50 g of acetone/special boiling point spirit 60/95 (1:1), after 4.5 hours with 50 g of acetone, after 6.5 hours with 70 g of acetone/special boiling point spirit 60/95 (1:1) and after 7.5 hours with 50 g of acetone. The polymerization is terminated by cooling after a reaction time of 24 hours, and the product is diluted down to 30% by addition of special boiling point spirit 60/95.

Gel permeation chromatography (test B) against polystyrene standards gave M_{N}=112 000 g/mol and M_{W}=237 000 g/mol.

Results

Following production of the test specimens, the bond strength of the PSA sheets was first of all determined in accordance with test method A. As well as the absolute values, the PSA sheet must be removable from the paper surface without picks from the paper and without residues of adhesive.

The measurements are summarized in Table 1:

TABLE 1

| | BS paper/test A | Appearance of |
|---|---|---|
| Example | [N/cm] | fracture (inspection) |
| 1 | 0.20 | OK |
| 2 | 0.22 | OK |
| 3 | 0.15 | OK |
| 4 | 0.14 | OK |

BS: instantaneous bond strength in N/cm
OK: no tears from paper and no transfer of adhesive

From the values measured it is apparent that the PSA sheets all have a relatively low bond strength to paper, can be parted from one another effectively, and also do not give rise to any observation of tears or PSA residues on removal. Correspondingly, the sheet samples can be laminated atop one another very effectively and used as PSA sheet material.

To produce a product, 10 DIN A4 sheets of graphics paper from Paper Union GmbH & CO. KG, Kompass Copy TCF office, 80 g/m², were further coated with a 1.5 cm wide PSA film from Example 4 on one side, laminated atop one another and then cut, with the PSA rim facing upward, to a size of 7.5×10 cm, the PSA portion having a size of 1.5 cm×10 cm and finishing off the top end. A block-type notepad with a construction of this kind was stored for one week at 50% humidity and 40° C. After the end of storage, the individual PSA sheets could still be removed from the block without residue and adhered to a variety of substrates without the PSA sheet falling down.

1. A pressure-sensitive adhesive article comprised of a support in sheet or strip form coated on at least one side at least partly with a polyacrylate-based pressure-sensitive adhesive, wherein the pressure-sensitive adhesive comprises at least one polyacrylate block copolymer that has a succession of hard polymer blocks [P(A)] having a glass transition temperature of not more than 10° C. and soft polymer blocks [P(B)] having a glass transition temperature of more than 10° C.

2. The pressure-sensitive adhesive article of claim 1, wherein the block copolymer has at least one triblock structure P(A)-P(B)—P(A) or P(B)—P(A)-P(B) or at least one of each.

3. The pressure-sensitive adhesive article of claim 1, wherein the block copolymer has functional groups at least of a type which behave inertly in a free-radical polymerization reaction and contribute to an increasing cohesion or are suitable for subsequent crosslinking of the pressure-sensitive adhesive.

4. The pressure-sensitive adhesive article claim 1, wherein the support is coated at least partially on only one side, and at least part of the side facing away from the pressure-sensitive adhesive provided with a release coat.

5. The pressure-sensitive adhesive article of claim 1, wherein the support, on the side facing away from the pressure-sensitive adhesive, has been is provided at least partly with an adhesion-promoting primer.

6. The pressure-sensitive adhesive article of claim 1, in the form of a pressure-sensitive adhesive sheet within a pad of said sheets, comprising at least two of said pressure-sensitive adhesive sheets lying one atop another.

7. The pressure-sensitive adhesive article of claim 1 in the form of a strip rolled onto a core.

8. The pressure-sensitive adhesive article of claim 1, wherein the support is paper.

9. The pressure-sensitive adhesive article of claim 1, wherein the block copolymer has oriented in a preferential direction, the refractive index measured, n_{MD}, being greater than the refractive index n_{CD} measured in a direction perpendicular to the preferential direction, and the measured difference Δn=n_{MD}−n_{CD} amounts to at least 1·10⁻⁵.

10. The pressure-sensitive adhesive article of claim 5, wherein said primer is provided in an area opposite the pressure-sensitive adhesive.

11. The pressure-sensitive adhesive article of claim 8, wherein said paper is white, transparent, colored, printed or graphics paper.
